(19) United States
(12) Patent Application Publication
(10) Pub. No.: US 2018/0315335 A1
(43) Pub. Date: Nov. 1, 2018

(54) ENGINE FOR DRIVING A SYSTEM FOR ASSESSING AND DEVELOPING THE MENTAL ACUITY AND BEHAVIOR OF A PERSON

(71) Applicant: APTUS, AUSTIN, TX (US)

(72) Inventors: MARK MANGUM, WEST LAKE HILLS, TX (US); LEW WILLIAMS, AUSTIN, TX (US); DICK DANIELS, WAYNE, PA (US); NANCY OLSEN, AUSTIN, TX (US)

(73) Assignee: APTUS, AUSTIN, TX (US)

(21) Appl. No.: 14/970,557

(22) Filed: Dec. 16, 2015

(51) Int. Cl. G09B 19/00

(52) U.S. Cl. CPC G09B 19/00

(57) ABSTRACT

An engine and a method for driving a system for assessing and developing the mental acuity and behavior of a person are provided. The engine comprises a behavioral science compute server for receiving gesture, accelerometer, gyro and metadata from at least one of a computer, a tablet and a smart phone, The gesture, accelerometer, gyro and metadata tare used to develop user profile data which is then forwarded by a reporting compute server back to said at least one of the computer, the tablet and the smart phone. In addition the gesture, accelerometer, gyro and metadata are forwarded to a computer for offline behavior analysis.

### BACKGROUND OF THE INVENTION

Knowing how to understand and develop a person mentally is critical to maximizing that person's performance in athletic professions, other professions educational environments. In athletic professions and activities, players' physical abilities are known and cross checked thoroughly. Height, weight, speed, agility, strength and skill are precisely measured and benchmarked continuously. However, in order to fully maximize an athlete's physical skills we must first know how the athlete acquires and applies instructional information (i.e., how the athlete learns). To be more specific, we must know how that athlete defines, processes and executes information and instruction.

In the National Football League (NFL), for example, players are analyzed based on three areas:
1) Skill—the physical ability, knowledge and capacity to carry out required responsibilities;
2) Critical Factors—the athletic skills necessary to implement techniques that are required to execute instructions during competition;
3) Mental Acuity and Character—the ability to process instructional information that leads to accurate application under competitive conditions and the ability to emotionally overcome the success or failure of the application, establishing cognitive mental attitude which eliminates distraction in the next phase of future competition or responsibilities.

Accordingly, methods and systems for assessing and developing the mental acuity and behavior of a person were developed by the inventors of the present application.

The development of the methods and systems for assessing and developing the mental acuity and behavior of a person necessarily involved the development of an engine for driving the systems.

### SUMMARY OF THE INVENTION

The present invention relates to an engine for carrying out the methods and systems for assessing and developing the mental acuity and behavior of a person, that is, an engine for driving the system for assessing and developing the mental acuity and behavior of a person. According to an embodiment, a method of assessing mental acuity and character comprises using a computer system and executing user interactive exercises involving the use of at least one of visual acuity skills, operational thinking skills and behavioral skills of a user. During execution of each user interactive exercise, the computer system receives user inputs including body movement of a user and touch interaction between the user and a user interface in communication with the computer system. The computer system measures and records performance data related to the timing and accuracy of the user inputs in each user interactive exercise, and processes the performance data to generate scores in assessment categories that provide measurements of at least one of the visual acuity skills, operational thinking skills and behavioral skills of the user.

According to another embodiment, a programmable computer memory comprises stored instructions executable to conduct user interactive exercises involving the use of at least one of visual acuity skills, operational thinking skills and behavioral skills of a user. While each user interactive exercise is conducted, the instructions are executable to process user inputs including body movement of the user and touch interaction between the user and a user interface in communication with a computer system. For each user interactive exercise, the instructions are executable to measure and record performance data related to the timing and accuracy of the user inputs. The instructions are further executable to process the performance data to generate scores in assessment categories that provide measurements of at least one of the visual acuity skills, operational thinking skills and behavioral skills of the user.

According to another embodiment, a computer system comprises a user interface, one or more processors and one or more memories, and is configured to execute user interactive exercises involving the use of at least one of visual acuity skills, operational thinking skills and behavioral skills. The computer system is configured to measure and record performance data related to the timing and accuracy of user inputs for each user interactive exercise. The computer system is further configured to process the performance data to generate scores in assessment categories that provide measurements of at least one of the visual acuity skills, operational thinking skills and behavioral skills of a user.

According to another embodiment, a method of assessing performance abilities and tendencies of an athlete comprises, using a computer system, executing user interactive exercises involving the use of visual acuity skills, operational thinking skills and behavioral skills of an athlete. During execution of each user interactive exercise, the computer system receives user inputs including body movement of a user and touch interaction between the athlete and a user interface in communication with the computer system. The computer system measures and records performance data related to timing and accuracy of the user inputs in each user interactive exercise, and processes the performance data to generate scores in assessment categories that provide measurements of at least one of the visual acuity skills, operational thinking skills and behavioral skills of the athlete.

The disclosed invention enables participants to be assessed more quickly and efficiently. In athletic professions or activities, quality and efficient practice repetitions increase and practice sessions are optimized. Team acclimation increases, mastery quickens, and performance improves. Athletes become “game ready” more quickly than previously thought possible. Similarly, in other professional fields or educational fields, work or study performance becomes more efficient and optimized, and mastery of professional or educational activities quickens. The invention mitigates risk and maximizes investments in developing athletes, employees and students.

Additional features and benefits of the invention will be apparent to those of skill in the art from the following detailed description.

### BRIEF DESCRIPTION OF THE DRAWINGS

FIG. 1 is a diagram of an engine driving a system for assessing and developing the mental acuity and behavior of a person according to an embodiment of the present invention.

FIG. 2 is a flow chart of the operations carried out by the engine which drives the system for assessing and developing the mental acuity and behavior of a person according to an embodiment of the present invention.

### DETAILED DESCRIPTION

The following detailed description relates to an engine for driving the system for discovering and assessing the mental acuity and character of an individual. The methods and systems disclosed herein can be used to assess and develop athletes, employees, students and individuals in general.

The following characteristics can be determined by use of the present invention: (1) visual activity; (2) optical history; (3) behavior or character; (4) assessment category methodology; and (5) assessment tool and process overview.

Visual acuity can be defined as including the following visual characteristics:
1) overall vision or ocular health—the physical/medical condition of the eye, degree of freedom from disease so that the eye may perform proper eye movement and sight;
2) peripheral vision—the external or outer boundary of the line of vision or sight;
3) hand-eye coordination—the ability to see and use the hand(s) to actively arrange what is seen in harmonious order according to proper relationships;
4) speed and agility of visual adaptation with logic and accuracy—the ability to quickly see and mentally incorporate the physical to adjust what is seen in accordance with principles of logic; and
5) imagery or stereoptic—the ability of each eye to look upon an object as one picture so that the two images are conveyed to brain as one picture.
   In the context of football, the category of visual acuity is often referred to as “read and react.”

Behavior can be defined as including:
1) interpersonal skills (i.e., feelings)—inner feelings an individual possesses, such as aggression and self-image; and
2) intrapersonal skills (i.e., self-motivation)—intra-feelings an individual possesses, such as competitiveness and involvement.

In the context of football, the category of behavior or character is often referred to as “on-the-field/off-the-field character, mental toughness and passion.”

The assessment of behavior or character can be accomplished through the assessment of:
a) aggression—the overt or suppressed hostility, either innate or resulting from feelings and/or desires and directed outward;
b) self-image—an individual's perception of oneself, and an individual's awareness of, and attitudes toward, his/her own physical and/or biological person;
c) competitiveness—an individual's interest in and/or suitability for competition and desire to compete; and
d) involvement—the act of participating.
   Accordingly, the methods and systems disclosed herein are adapted to assess behavior/character through the assessment of the characteristics above.

Athletes implement the following four phases during their physical performance:
1) Seeing;
2) Diagnosing the situation;
3) Positioning the body; and
4) Execution
   These phases are implemented during physical performance in the order in which they are listed above. Accordingly, the assessment/development methods and tools according to the inventions can be adapted to monitor these phases in the order specified above.

According to exemplary embodiments of the invention, an assessment can include one or more of the following exercises: (1) an exercise involving drawing a person; (2) an exercise involving drawing a three-dimensional structure; (3) a route reconstruction exercise; (4) a spatial orientation exercise; (5) an exercise involving drawing a pilot's view of a structure; (6) a crossword puzzle exercise; (7) a letter/symbol placement exercise; (8) a letter/symbol maze exercise; (9) a finger/stylus reaction and placement exercise; and (10) an icon interception exercise. According to a preferred embodiment, an assessment includes all of the aforementioned ten exercises.

Assessment Analysis and Reporting

According to the present invention, the participant's performance in each assessment exercise can be analyzed individually and reported in an assessment report. The assessment report can be a computer-generated report displayed on the display of the user device used by the participant being assessed. Additionally, the assessment report can be stored on a memory device for viewing on any PC or other computer device. A printed assessment report can also be provided. Furthermore, the assessment report can provide scores in specific measurement categories that, based on processing of timing and accuracy data recorded by the assessment software, measure visual acuity, operational thinking and behavior skills of the participant. The assessment report can provide percentile rankings of the participant with respect to other participants (e.g., peers in the participant's sport, profession or activity). Percentile rankings can be calculated based on the general population assessed, or based participants grouped by sport, profession or educational fields, for example.

Additionally, it should be understood that changes and variations can be made to the assessment methods, systems and exercises described herein without departing from the spirit and scope of the invention as set forth.

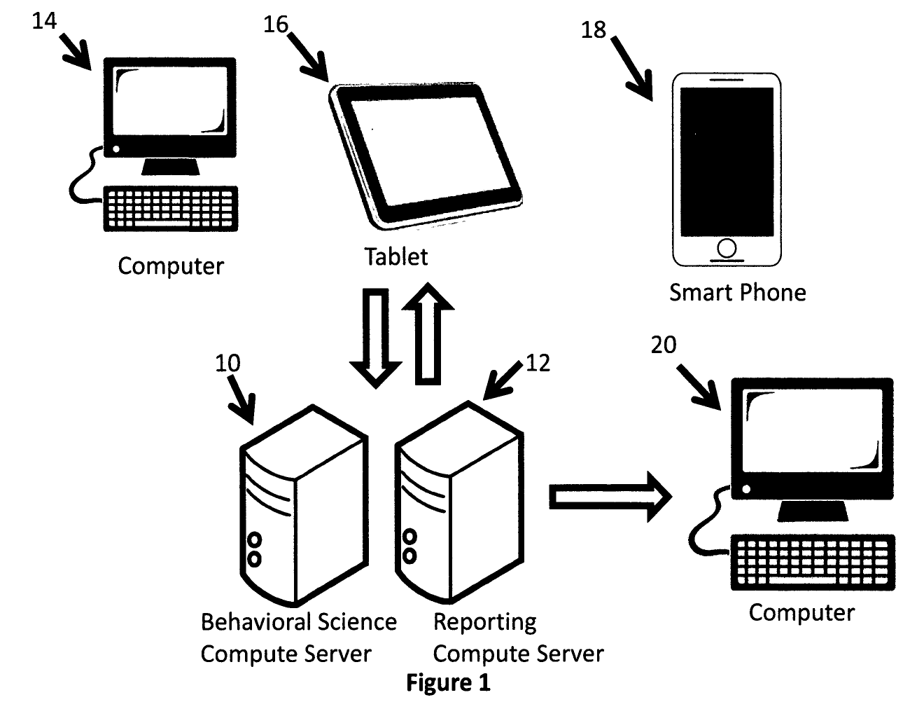

FIG. 1 is a diagram of an engine driving a system for assessing and developing the mental acuity and behavior of a person according to an embodiment of the present invention. Referring to FIG. 1, the engine for driving the system for assessing and developing the mental acuity and behavior of a person will now be described.

As seen in FIG. 1, the engine basically comprises a behavioral science compute server 10 and reporting compute server 12. The behavioral science compute server 10 is connected to a computer 14, tablet 16 and/or smart phone 18 located with the user. The engine is an advanced analytics engine that can be plugged into virtually any mobile software device or web site using the simple and easy to use software development kit (SDK). The SDK provides all necessary components to start capturing data and providing advanced reporting and real time updates.

Specifically, the installed SDK facilitates the transmission of captured gesture, accelerometer, gyro and metadata to the behavioral science compute server 10 of the engine. Once the engine processes the received data, the reporting compute server 12 transmits, to the computer 14, tablet 16 and/or smart phone 18, user profile data that can be used to make dynamic adjustments based on behavior of the user. Reception of the user profile data by the computer 14, tablet 16 and/or smart phone 18 is facilitated by the SDK. In addition, the reporting compute server 12 transmits, to the computer 20, behavior analytics to be reported for use in offline analysis.

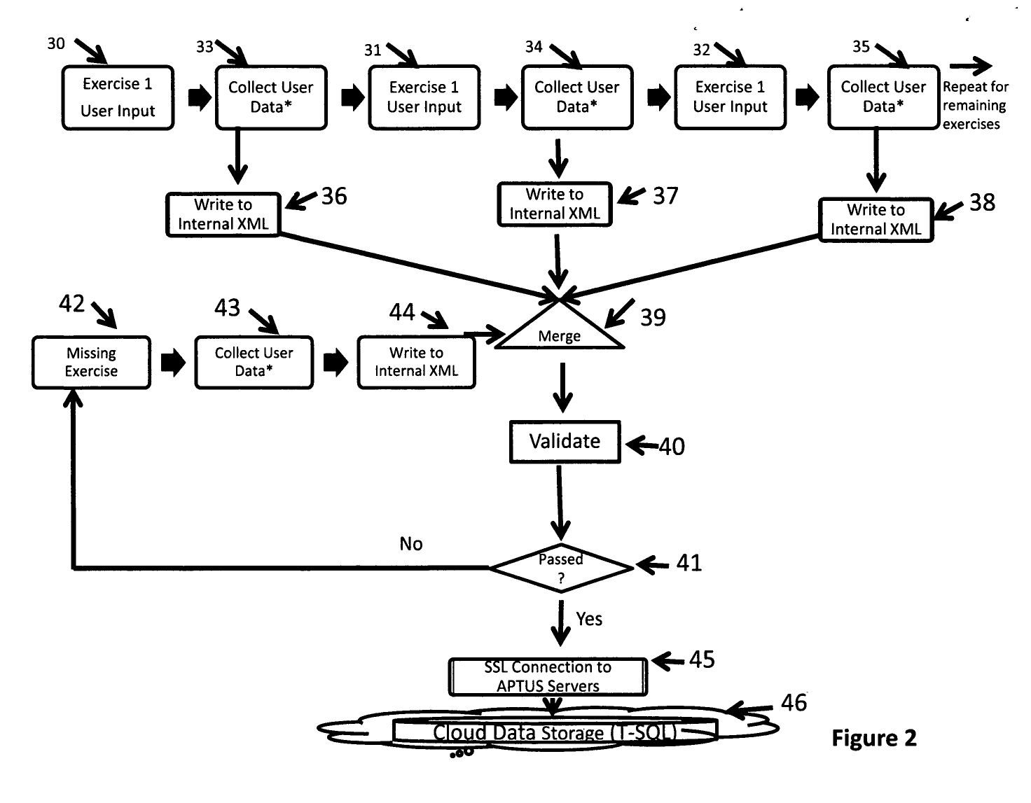

FIG. 2 is a flow chart of the operations carried out by the engine which drives the system for assessing and developing the mental acuity and behavior of a person according to an embodiment of the present invention. Referring to FIG. 2, the operations carried out by the engine which drives the system for assessing and developing the mental acuity and behavior of a person will now be described.

Initially, the user performs exercises under the control of the SDK and user inputs corresponding to the performed exercises are produced (see blocks 31, 31 and 32 of FIG. 2). It should be noted that changes and variations can be made to the exercises disclosed therein without departing from the spirit and scope of the invention as set forth herein.

As each exercise or part of an exercise is performed, user data are collected (see blocks 33, 34 and 35 of FIG. 2), and the collected data are written or provided to internal XML units (see blocks 36, 37 and 38 of FIG. 2).

Each internal XML unit provides the collected data so that the collected data are merged (see block 39 of FIG. 2).

Once the collected data is merged, a validation process is carried out (see block 40 of FIG. 2).

If validation is successful and the collected data passes validation (see block 41 of FIG. 2), the collected data is connected to servers (see block 45 of FIG. 2).

However, if validation is not successful and the collected data does not pass validation (see block 41 of FIG. 2), it is determined that a valid exercise is missing (see block 42 of FIG. 2), appropriate user data is collected (see block 43 of FIG. 2), the collected data is written to the internal XML unit (see block 44 of FIG. 2), and merger of the collected data again takes place (see block 39 of FIG. 2).

At this point, validation of the collected data again takes place (see block 40 of FIG. 2), and if the validation process is passed (see block 41 of FIG. 2), the collected data is connected to servers (see block 45 of FIG. 2), and final storage of the collected data takes place (see block 46 of FIG. 2).

While preferred forms and arrangements have been presented in disclosing the present invention, it should be noted that various variations in form and arrangement may be provided without departing from the spirit and scope of the invention.

We claim:

1. An engine for driving a system for assessing and developing mental acuity and behavior of a person, comprising:
a behavioral science compute server for receiving gesture, accelerometer, gyro and metadata from at least one of a computer, a tablet and a smart phone, and for using the gesture, accelerometer, gyro and metadata to develop a user profile; and
a reporting compute server for forwarding user profile data to said at least one of the computer, the tablet and the smart phone.

2. The engine of claim 1, wherein the reporting compute server additionally forwards the gesture, accelerometer, gyro and metadata to a computer for offline behavior analysis.

3. The engine of claim 1, wherein a software development kit is installed for the purpose of facilitating sending of the gesture, accelerometer, gyro and metadata to the behavioral science compute server.

4. The engine of claim 1, wherein a software development kit is installed for the purpose of facilitating reception of the user profile data from the reporting compute server.

5. The engine of claim 1, wherein said at least one of the computer, the tablet and the smart phone uses the user profile data in making dynamic adjustments based on behavior.

6. An engine for driving a system for assessing and developing mental acuity and behavior of a person, comprising:
a behavioral science compute server for receiving gesture, accelerometer, gyro and metadata from at least one of a computer, a tablet and a smart phone; and
a reporting compute server for forwarding the gesture, accelerometer, gyro and metadata to a computer for offline behavior analysis.

7. The engine of claim 6, wherein the behavioral science compute server processes the gesture, accelerometer, gyro and metadata to develop a user profile, and wherein the reporting compute server forwards user profile data to said at least one of the computer, the tablet and the smart phone.

8. The engine of claim 7, wherein said at least one of the computer, the tablet and the smart phone uses the user profile data in making dynamic adjustments based on behavior.

9. The engine of claim 7, wherein a software development kit is installed for the purpose of facilitating reception of the user profile data from the reporting compute server.

10. The engine of claim 6, wherein a software development kit is installed for the purpose of facilitating sending of the gesture, accelerometer, gyro and metadata to the behavioral science compute server.

11. A method of driving a system for assessing and developing mental acuity and behavior of a person, the method comprising the steps of:
receiving gesture, accelerometer, gyro and metadata from at least one of a computer, a tablet and a smart phone;
using the gesture, accelerometer, gyro and metadata to develop a user profile; and
forwarding user profile data to said at least one of the computer, the tablet and the smart phone.

12. The method of claim 11, further comprising the step of installing a software development kit for the purpose of facilitating sending of the gesture, accelerometer, gyro and metadata from said at least one of the computer, the tablet and the smart phone.

13. The method of claim 11, further comprising the step of installing a software development kit for the purpose of facilitating reception of the user profile data by said at least one of the computer, the tablet and the smart phone

14. The method of claim 11, further comprising the step of forwarding the gesture, accelerometer, gyro and metadata to a computer for offline behavior analysis.

15. The method of claim 11, further comprising the step of using the user profile data in making dynamic adjustments based on behavior.
